(19) United States
(12) Patent Application Publication
(10) Pub. No.: US 2003/0036587 A1
(43) Pub. Date: Feb. 20, 2003

(54) Rheology-controlled epoxy-based compositons

(76) Inventor: Kyra M Kozak, Rocky Hill, CT (US)

Correspondence Address: Henkel Loctite Corporation, Legal Department, 1001 Trout Brook Crossing, Rocky Hill, CT, 06067, US

(21) Appl. No.: 10/204,871

(22) PCT Filed: Apr. 23, 2001
(86) PCT No.: PCT/US01/11727

(51) Int. Cl. C08K 3/00

(52) U.S. Cl. 523/445

(57) ABSTRACT

This invention relates to rheology-controlled epoxy-based compositions, particularly well suited for use in coating applications such as in the assembly of ink jet printheads for the printing industry, and in the microelectronics industry such as in the assembly of semiconductor devices.

### FIELD OF THE INVENTION

This invention relates to rheology-controlled epoxy-based compositions, particularly well suited for use in coating applications such as in the assembly of ink jet printheads for the printing industry, and in the microelectronics industry such as in the assembly of semiconductor devices.

### BRIEF DESCRIPTION OF RELATED TECHNOLOGY

Epoxy-based compositions are well known. In fact, epoxy-based compositions are available for a variety of end uses.

In one such application, assembly of inkjet printheads, the components undergo a wide variation in temperature. Typically, a flex circuit is first adhered to a silicon substrate via a barrier film. Portions of both the flex circuit and the substrate then are adhered to the pen body. To adhere the portions of the flex circuit to the pen body, the adjacent structures are heated to elevated temperatures, to cure an adhesive that has been applied to a groove about an opening in the pen body, so as to bond the flex circuit to the pen body. After curing, the pen is cooled to room temperature. In certain instances, the adhesive that has been applied may “run” out of the groove, particularly as the temperature begins to increase during the curing process. As this occurs, the adhesive tends to enter, and obstruct or clog (eventually permanently when cured) the nozzles of the flex circuit, through which ink drops are intended to be ejected. This event may lead to poor transfer of ink to paper at best, and oftentimes prevents the ink from flowing through the nozzles at all. [See e.g. U.S. Pat. No. 5,825,389 (Cowger).] The problem may be solved by appropriate adjustment of the Theological properties of the adhesive.

Rheology control is oftentimes effected by the addition of fillers to increase viscosity, or the removal of fillers and/or the addition of plasticizers to improve flow. While seemingly a simple matter, many adhesive compositions, particularly those that are epoxy based, already include fillers for other reasons. For instance, certain fillers may be added to the adhesive composition to confer thermal conductivity to the adhesive compositions. Other fillers may be added to aid in matching the coeffecients of thermal expansion (“CTE”) between the substrates between which the adhesive is intended to be placed. Still other fillers may be added to improve yield point (the three dimensional structure of the adhesive composition). As such, addition of further fillers to build rheology may prove too much to allow for ready dispensing and may interfere with the dispensing process. In the context of ink jet printheads, the addition of fillers to build viscosity may also result in clogging or obstructing the nozzles through which ink is to flow, in the event some wicking of the adhesive occurs.

The removal of fillers to improve flow may interfere with thermal conductivity, CTE matching and/or yield point improvement. And the inclusion of a plasticizer to improve flow may adversely affect adhesion.

Thus it is seen that conventional ways in which rheology may be controlled may not suit certain applications for which a particular adhesive is to be tailored, such as in the bonding of a printhead, such as a tape head assembly, to a printhead housing. Clearly, therefore in that regard a need is present for a way in which a bond line may be achieved without adversely impacting the ejection passageways of an ink jet printhead.

In addition, perhaps one of the most wide spread uses of an epoxy-based composition is in the assembly of microelectronic devices. Advances in the electronics industry have made precise deposition of epoxy-based compositions a critical processing parameter, particularly in view of the demands for high throughput and process efficiency. To that end for many microelectronic applications it has become desirable to adjust the flow of an adhesive formulation to meet such demands.

For instance, in underfill applications where the adhesive formulation is intended to flow between a semiconductor device and a carrier substrate to provide a material whose coefficient of thermal expansion is intermediate between that of the semiconductor device and the carrier substrate, it is important to provide an adhesive formulation with suitable flow characteristics to allow for penetration into the gap between the semiconductor device and the carrier substrate. As noted above, flow may be improved by adding a plasticizer. However, the addition of such a plasticizer is not without cost. That is, inclusion of such plasticizers may impact adversely the physical properties of the cured adhesive, such as weakening the strength of the adhesive bond formed.

In other microelectronic applications, such as chipbonding applications where a surface mount adhesive is used for bonding electronic components to printed circuit boards, it is desirable to improve the yield point so that once it is dispensed onto a substrate the adhesive composition will stand proud on the substrate.

In addition to the use of fillers to thicken the adhesive composition, as noted above, it is also desirable for these compositions to have a defined structural integrity. One way to achieve this is through the addition of a thixotropy-conferring agent, such as a clay or a silica, a large number of which are well-known. Indeed, Degussa makes available commercially a number of treated fumed silicas under the tradename AEROSIL, and has suggested their use to impart in epoxy resins a thickening and thixotropic effect. See also C. D. Wright and J. M. Muggee, “Epoxy Structural Adhesives” in Structural Adhesives: Chemistry and Technology, S. R. Hartshorn, ed., 113-79, 131 (1986).

In a recent advance by Loctite Corporation, improved yield point maintenance and viscosity maintenance over time has been achieved in epoxy-based compositions using a solid organic acid. (See International Patent Application No. PCT/IE99/00001.)

Where precise adhesive deposition does not occur in surface mounting applications—either due to adhesive deposition technique imprecision, or spreading of the adhesive due to inappropriate rheological properties for the particular application, or both—component mounting may not occur at all, and even when mounting does occur, the mounting may not occur in a commercially-acceptable manner.

Carrier substrates and semiconductor devices used to assemble microelectronics devices are oftentimes constructed of, layered with or contain hard-to-bond materials, such as liquid crystal polymers, polyamides or silicone dies. As such, it is desirable to improve the adhesion of adhesive compositions to such substrates by adding adhesion-promoting materials or to first prime the surface of the substrates with an activator material prior to dispensing the adhesion formulation, the former being preferred in view of additional processing steps and decreased throughput observed with the latter, and the often unavailable space for a priming step.

It would be desirable to provide to epoxy-based compositions adhesion promoting materials that also are capable of modifying the rheology of the compositions, so as to render the compositions with flow characteristics appropriate for the sought after end-use application.

### SUMMARY OF INVENTION

The present invention provides epoxy-based compositions with controllable rheological properties. Broadly speaking, the invention provides compositions that include an epoxy component, a rheology-control agent, and a curing agent.

Of course, the invention provides reaction products of these epoxy-based compositions as well.

In addition, the invention provides a method of controlling the viscosity of epoxy-based compositions without compromising the adhesive strength of reaction products of such compositions.

The invention also provides a method of preparing such epoxy-based compositions, and a method of using such epoxy-based compositions in the assembly of ink jet printheads or microelectronic semiconductor devices.

The present invention will be more fully understood by a reading of the “Detailed Description of the Invention”, with reference to the figures, which follow.

### BRIEF DESCRIPTION OF THE DRAWINGS

FIG. 1 is a perspective view of an ink jet printhead assembled with an epoxy composition according to the present invention.

FIG. 2 depicts a cross-sectional view showing an example of a flip chip assembly with which an epoxy composition according to the present invention is used as an underfill sealant.

FIG. 3 depicts a cross-sectional view showing an example of a semiconductor device to be mounted to a circuit board with an epoxy composition according to the present invention.

FIG. 4 depicts a cross-sectional view showing an example of a mounted structure with which an epoxy composition according to the present invention is used as an underfill sealant.

### DETAILED DESCRIPTION OF THE INVENTION

The present invention provides epoxy-based compositions having controlled rheological properties. Broadly speaking, the invention provides compositions that include an epoxy component, a rheology-control agent, and a curing agent.

The epoxy resin component of the present invention may include any common epoxy resin, such as a multifunctional epoxy resin. Ordinarily, the multifunctional epoxy resin should be included in an amount within the range of about 15 weight percent to about 75 weight percent of the total of the epoxy resin component. In the case of bisphenol-A-type epoxy resin, desirably the amount thereof should be in the range of from about 35 to about 65 weight percent, such as about 40 to about 50 weight percent of the total of the epoxy resin component.

Examples of the multifunctional epoxy resin include bisphenol-A-type epoxy resin (such as RE-310-S from Nippon Kayaku, Japan), bisphenol-F-type epoxy resin (such as RE-404-S from Nippon Kayaku), phenol novolac-type epoxy resin, and cresol novolac-type epoxy resin (such as ARALDITE ECN 1871 from Ciba Specialty Chemicals, Hawthorne, N.Y. or XD-10002-L from Nippon Kayaku).

Other suitable epoxy resins include polyepoxy compounds based on aromatic amines and epichlorohydrin, such as N,N,N′,N′-tetraglycidyl-4,4′-diaminodiphenyl methane; N-diglycidyl-4-aminophenyl glycidyl ether; and N,N,N′,N′-tetraglycidyl-1,3-propylene bis-4-aminobenzoate.

Among the epoxy resins suitable for use herein also include polyglycidyl derivatives of phenolic compounds, such as those available commercially under the tradename EPON, such as EPON 828, EPON 1001, EPON 1009, and EPON 1031 from Shell Chemical Co.; DER 331, DER 332, DER 334, and DER 542 from Dow Chemical Co.; and BREN-S from Nippon Kayaku. Other suitable epoxy resins include polyepoxides prepared from polyols and the like and polyglycidyl derivatives of phenol-formaldehyde novolacs, the latter of which are available commercially under the tradename DEN, such as DEN 431, DEN 438, and DEN 439 from Dow Chemical. Cresol analogs are also available commercially under the tradename ARALDITE, such as ARALDITE ECN 1235, ARALDITE ECN 1273, and ARALDITE ECN 1299 from Ciba Specialty Chemicals. SU-8 is a bisphenol-A-type epoxy novolac available from Interez, Inc. Polyglycidyl adducts of amines, aminoalcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE 0500, and ARALDITE 0510 from Ciba Specialty Chemicals and PGA-X and PGA-C from the Sherwin-Williams Co.

And of course combinations of the different epoxy resins are also desirable for use herein.

The rheology control agent should be used in an amount within the range of about 0.01 to about 2 percent by weight, such as about 0.1 to about 1 percent by weight.

The rheology control agent includes silanes, such as epoxy silanes [e.g., glycidyl trimethoxysilane (commercially available from OSI under the trade designation A-187)], and amino silanes [e.g., gamma-amino propyl triethoxysilane (commercially available from OSI under the trade designation A-1100)]. In addition, trialkoxysilyl isocyanurate derivatives (e.g., Y-11597 from OSI) may also be used. Typically, use of the epoxy silanes in the inventive epoxy-based compositions will tend to impart thixotropy on the compositions, and use of the amino silanes in the inventive epoxy-based compositions will tend to impart improved flow characteristics on the compositions. These rheology control agents also promote adhesion to hard-to-bond surfaces.

The curing agent is capable of catalyzing polymerization of the epoxy resin component of the inventive compositions.

The curing agent may be used in an amount of from about 1 to about 25 percent by weight, such as from about 5 to about 8 percent by weight, desirably about 6 to about 6.5 percent by weight of the total composition.

Desirable curing agents for use with the present invention include nitrogen-containing compounds, such as amine compounds, amide compounds, imidazole compounds, and combinations thereof.

Examples of amine compounds include aliphatic polyamines, such as diethylenetriamine, triethylenetetraamine and diethlylaminopropylamine; aromatic polyamines, such as m-xylenediamine and diaminodiphenylamine; and alicyclic polyamines, such as isophoronediamine and menthenediamine.

Of course, combinations of these amine compounds are also desirable for use in the compositions of the present invention.

Examples of amide compounds include cyano-functionalized amides, such as dicyandiamide.

The imidazole compounds may be chosen from imidazole, isoimidazole, and substituted imidazoles—such as alkyl-substituted imidazoles (e.g., 2-methyl imidazole, 2-ethyl-4-methylimidazole, 2,4-dimethylimidazole, butylimidazole, 2-heptadecenyl-4-methylimidazole, 2-methylimidazole, 2-undecenylimidazole, 1-vinyl-2-methylimidazole, 2-undecylimidazole, 2-heptadecylimidazole, 2-ethyl 4-methylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole and addition products of an imidazole and trimellitic acid, 2-n-heptadecyl-4-methylimidazole and the like, generally where each alkyl substituent contains up to about 17 carbon atoms and desirably up to about 6 carbon atoms), and aryl-substituted imidazoles [e.g., phenylimidazole, benzylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5-diphenylimidazole, 2-(p-dimethylaminophenyl)-4,5-diphenylimidazole, 2-(2-hydroxyphenyl)-4,5-diphenylimidazole, di(4,5-diphenyl-2-imidazole)-benzene-1,4,2-napthyl-4,5-diphenylimidazole, 1-benzyl-2-methylimidazole, 2-p-methoxystyrylimidazole, and the like, generally where each aryl substituent contains up to about 10 carbon atoms and desirably up to about 8 carbon atoms].

Examples of commercially available imidazole compounds include those from Air Products, Allentown, Pa. under the trade designation CUREZOL 1B2MZ, from Synthron, Inc., Morganton, N.C. under the trade designation ACTIRON NXJ-60, and from Borregaard Synthesis under the trade designation CURAMID CN.

Of course, combinations of these imidazole compounds are also desirable for use in the compositions of the present invention.

Where an inorganic filler component is used in the inventive compositions, the fillers are used for the purpose of providing thermal conductivity, CTE matching and/or yield point improvement. These fillers may be chosen from reinforcing silicas, such as fused or fumed silicas, which may be treated or untreated so as to alter the chemical nature of their surface, may be used,

Examples of such treated fumed silicas include polydimethylsiloxane-treated silicas and hexamethyldisilazane-treated silicas. Such treated silicas are commercially available, such as from Cabot Corporation under the tradename CAB-O-SIL ND-TS and Degussa Corporation under the tradename AEROSIL, such as AEROSIL R805.

Of the untreated silicas, amorphous and hydrous silicas may be used. For instance, commercially available amorphous silicas include AEROSIL 300 with an average particle size of the primary particles of about 7 nm, AEROSIL 200 with an average particle size of the primary particles of about 12 nm, AEROSIL 130 with an average size of the primary particles of about 16 nm; and commercially available hydrous silicas include NIPSIL E150 with an average particle size of 4.5 nm, NIPSIL E200A with and average particle size of 2.0 nm, and NIPSIL E220A with an average particle size of 1.0 nm (manufactured by Japan Silica Kogya Inc.).

Desirable ones also have a low ion concentration and are relatively small in particle size (e.g., on the order of about 2 microns), such as the silica commercially available from Admatechs, Japan under the trade designation SO-E5. Other desirable ones include ZEOTHIX 95, which is an amorphous precipitated silica (commercially available from J. M. Huber Corporation).

Still other desirable materials for use as the inorganic filler component include those constructed of or containing aluminum oxide, silicon nitride, aluminum nitride and silica-coated aluminum nitride.

The inorganic filler component should be used in the inventive compositions in an amount within the range of 5 to 40 percent by weight, such as about 20-28 percent by weight, desirably about 24 percent by weight of the composition.

The rheology-controlled epoxy-based compositions may further include an anhydride component. Examples of anhydrides include mono- and poly-anhydrides, such as hexahydrophthalic anhydride (“HHPA”) and methyl hexahydrophthalic anhydride (“MHHPA”) (commercially available from Lindau Chemicals, Inc., Columbia, S.C., used individually or as a combination, which combination is available under the trade designation LINDRIDE 62C), 5-(2,5-dioxotetrahydrol)-3-methyl-3-cyclohexene-1,2-dicarboxylic anhydride (commercially available from ChrisKev Co., Leewood, Kans. under the trade designation B-4400) and nadic methyl anhydride.

When used, the cure agent may be present in an amount of from about 3 to about 100 percent by weight, based on the weight of the epoxy resin component, the chosen amount depending of course on the type and identity of the anhydride, and whether a cure agent is used as well.

In another aspect of the invention, there is provided a method of controlling the rheology of epoxy-based compositions. This method allows for a control of the rheology, without compromising the adhesive strength of reaction products of such compositions, which ordinarily would be observed due to conventional additives used for this purpose. The method involves adding to an epoxy-based composition an amount of a rheology-control agent sufficient to adjust the viscosity of the composition to the desired amount.

In a further aspect of the invention, there is provided a method of preparing such epoxy-based compositions. This method involves combining an epoxy resin component, a rheology control agent, and a curing agent, and optionally an inorganic filler component.

In still a further aspect of the invention, there is provided a method of using such epoxy-based compositions in the assembly of ink jet printheads or microelectronic semiconductor devices. The steps of this method include generally dispensing onto a substrate a sufficient amount of the curable one-part epoxy resin composition, positioning over the epoxy resin composition dispensed onto the substrate an electronic component, a flex circuit, or a pen body, mating the electronic component, flex circuit or pen body, respectively with the substrate to form an assembly, and exposing the assembly to conditions favorable to effect cure of the curable one-part epoxy resin composition.

Generally, for applications such as underfill sealants where a greater degree of flow is desirable, the epoxy-based compositions of this invention may be prepared by selecting the type and amount of various components to reach a viscosity at a temperature of 25° C. in the range of 500 to 70,000 cps, such as 800 to 3,000 cps, depending on the amount present of an inorganic filler component, so as to improve its ability to penetrate into the space (e.g., of 10 to 200 μm) between the circuit board and the semiconductor device. Where the adhesive should have flow characteristics appropriate to allow for rapid spreading about and around a grooved surface, the adhesive should have a viscosity at a temperature of 25° C. at 5 secs⁻¹ in the range of about 35,000 cps to about 70,000 cps and at 20 secs⁻¹ in the range of about 24,000 cps to about 40,000 cps. In addition, surface mount adhesives should have yield points in the range of about 30 Pa to about 70 Pa.

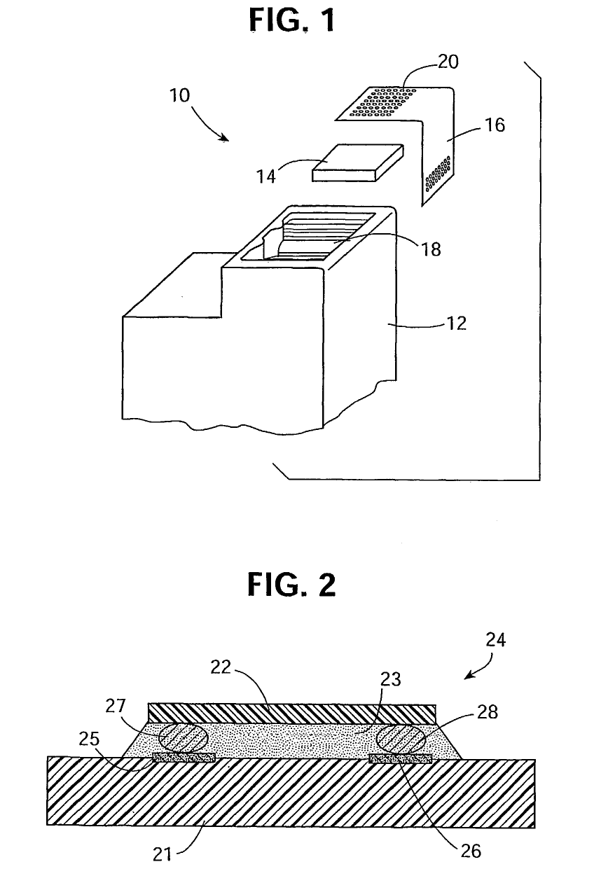

Commercial applications are illustrated with reference to the figures. For instance, FIG. 1 shows the printhead region of a conventional inkjet edge-feed pen 10. The pen includes a pen body 12, silicon substrate 14, and flex circuit 16. Ink is delivered to the ink chambers through ink channels that are in fluid communication with an ink supply. The ink supply may be, for example, contained in a reservoir part of the pen. During operation, ink flows from channel 18 to printhead nozzles 20. The nozzles are defined by the silicon substrate 14 and flex circuit 16. Thus, when a nozzle is fired, ink is ejected through the printhead nozzles 20 to a print media sheet.

During construction of the inkjet printhead, the flex circuit 16 is attached to the silicon substrate 14 using an adhesive. The flex circuit/substrate assembly is then attached to the pen body 12 using an adhesive. The pen body 12, substrate 14 and flex circuit 16 are heated to cure the adhesive. Once the adhesive cures, the pen body 12, substrate 14 and flex circuit 16 are fixed relative to each other at the adhering points.

In the event the adhesive wicks in and around the channel 18 and/or printhead nozzles 20 during construction, the adhesive may become embedded in either its uncured or cured state therein and therearound. This event impedes newly fired ink from the printhead and at best results in poor resolution of the ink emitted onto the ink receiving substrate. As such, tailoring the adhesive composition to have a rheology appropriate for the application may significantly reduce, if not eliminate, the potential for this occurrence.

Reference to FIG. 2 shows a FC assembly in which an epoxy composition of the present invention has been applied and cured.

The FC assembly 24 is formed by connecting a semiconductor chip (a bare chip) 22 to a circuit board 21 and sealing the space therebetween suitably with a thermosetting resin composition 23.

More specifically, for example, in the assembly of FC semiconductor devices using SBB technology, the semiconductor chip 22 may be passed over a substrate bearing a conductive adhesive paste (such as a metal-filled epoxy) to form a layer thereof on the semiconductor chip 22. The layer is ordinarily formed by a printing mechanism. The conductive adhesive paste may be applied on either the carrier substrate or the semiconductor chip. One way to do this is with the stencil claimed and described in International Patent Publication No. PCT/FR95/00898. Alternatively, this connection may also be made by an anisotropically conductive adhesive. See International Patent Publication No. PCT/US97/13677.

Thereafter, the semiconductor chip 22 is positioned over the carrier substrate 21 in such a manner so that the semiconductor chip 22 is in alignment with the electrodes 25 and 26 on the circuit board 21, now coated with a patterned layer of conductive adhesive paste or solder, 27 and 28. The conductive adhesive paste may be cured by a variety of ways, though ordinarily a heat cure mechanism is employed.

In order to improve reliability, the space between the semiconductor chip 22 and the circuit board 21 is sealed with an underfill sealing composition 23, such as is within to the scope of this invention, The epoxy-based compositions of the present invention penetrate and flow readily into the space between the semiconductor chip and the circuit board, or at least show a reduction in viscosity under heated or use conditions thus allow for ready penetration and flow.

The gel times of the compositions are often tailored to a specified period of time (such as 15 seconds, or 1 or 2 minutes) at a temperature of about 150° C. In such case, the inventive compositions should show no or substantially no increase of viscosity after a period of time of about six hours. With such a gel time, the compositions penetrate into the space (e.g., of 10 to 200 μm) between the circuit board and the semiconductor device relatively rapidly, and allow for a greater number of assemblies to be filled without observing a viscosity increase in the composition thereby rendering it less effective for application.

In use, the epoxy resin compositions of the present invention may be applied to a substrate in any conventional fashion. Suitable application modes include syringe dispensing, pin-transfer, screen printing, and through other conventional adhesive dispensing equipment.

The amount of composition applied should be suitably adjusted so as to fill almost completely the space between the circuit board and the semiconductor chip, which amount of course may vary depending on application. The thermosetting resin composition is then thermally cured by the application of heat. During the early stage of this heating, the thermosetting resin composition shows a significant reduction in viscosity and hence an increase in fluidity, so that it more easily penetrates into the space between the carrier substrate and the semiconductor chip. Moreover, by preheating the carrier substrate, the thermosetting resin composition is allowed to penetrate fully into the entire space between the carrier substrate and the semiconductor chip. The cured product of the thermosetting resin composition should completely fill that space.

The semiconductor chip ordinarily may be coated with a polyimide-, poly-benzocyclobutane- or silicone nitride-based material to passivate environmental corrosion.

Carrier substrates may be constructed from ceramic substrates of Al₂O₃, SiN₃ and mullite (Al₂O₃—SiO₂); substrates or tapes of heat-resistant resins, such as polyimides; glass-reinforced epoxy; ABS and phenolic substrates which are also used commonly as circuit boards; and the like. Any electrical connection of the semiconductor chip to the carrier substrate may be used, such as connection by a high-melting solder or electrically (or anisotropically) conductive adhesive and the like. In order to facilitate connections, particularly in SBB technology, the electrodes may be formed as wire bond bumps.

After the semiconductor chip is electrically connected to the carrier substrate, the resulting structure is ordinarily subjected to a continuity test or the like. After passing such test, the semiconductor chip may be fixed thereto with a thermosetting resin composition, as described below. In this way, in the event of a failure, the semiconductor chip may be removed before it is fixed to the carrier substrate with the thermosetting resin composition.

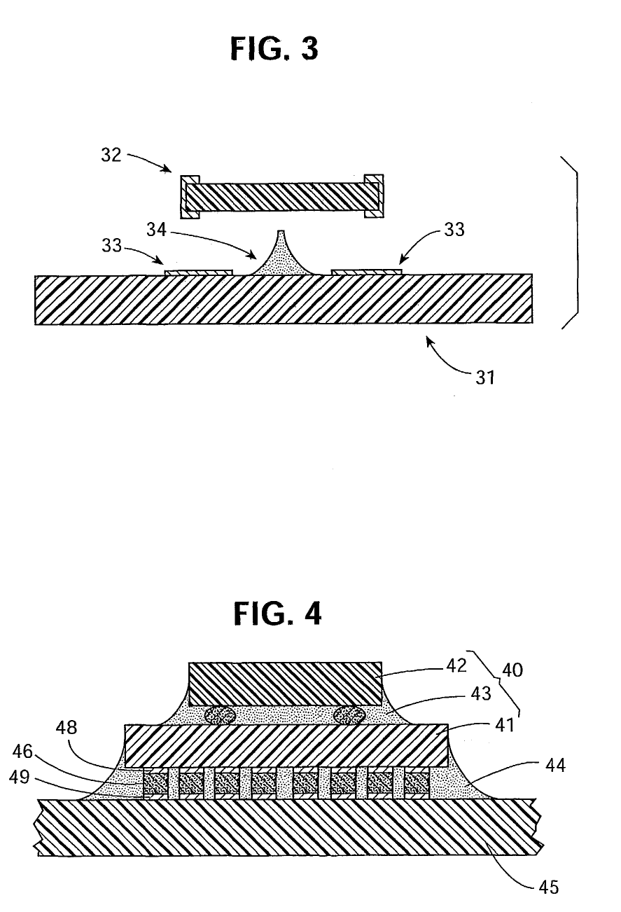

In a surface mount adhesive application and with reference to FIG. 3, a mounted structure (or chip scale package) on which an epoxy composition 34 within the scope of the invention, has been disposed onto a circuit board 31 between the solder lands 33 is shown. The semiconductor chip 32 is positioned over the location of the circuit board 31 onto which the epoxy composition 34 has been dispensed, and the circuit board and semiconductor chip is thereafter mated. FIG. 3 shows the epoxy composition 34 having been dispensed onto the circuit board 31; in certain instances it may be desirable to apply the composition onto the semiconductor chip 32 instead, or apply the composition onto both the circuit board 31 and the semiconductor chip 32. The composition is then cured, as above.

In the arrangement of FIG. 4 the semiconductor device (or chip scale package) 40 is one formed as noted above by electrically connecting a semiconductor chip 42 to a carrier substrate 41 and sealing the space therebetween with an underfill sealant 43, such as in accordance with the invention. This semiconductor device 40 is mounted using a surface mount adhesive 46 at a predetermined position of the circuit board 45, and electrodes 48 and 49 are electrically connected by a suitable connection means such as solder. In order to improve reliability, the space between semiconductor device 40 and circuit board 45 is sealed with an underfill sealant, also such as in accordance with the invention.

The compositions of the present invention may ordinarily be cured by heating to a temperature in the range of about 120 to about 200° C. for a period of time of about 0.5 minutes to about 2 hours. However, generally after application of the composition, an initial cure time of about 1 minute sets up the composition, and complete cure is observed after about 5 to about 15 minutes at about 165° C. Thus, the composition of the present invention can be used at relatively moderate temperatures and short-time curing conditions, and hence achieve very good productivity.

Cured reaction products of the compositions of the present invention demonstrate excellent adhesive force, heat resistance and electric properties, and acceptable mechanical properties, such as flex-cracking resistance, chemical resistance, moisture resistance and the like, for the applications for which they are used herein.

The present invention will be more readily appreciated with reference to the examples which follow.

### EXAMPLES

In these examples, epoxy-based compositions in accordance with the present invention were prepared and evaluated for performance.

### Epoxy-Based Composition

An epoxy-based composition in accordance with this invention was prepared by mixing together for a period of time of about 10 minutes at room temperature in an open vessel the following components in the order noted:

1. an epoxy resin component including

50 perecnt by weight of bisphenol-A-type epoxy resin (commercially available from Nippon Kayaku under the trade designation RE-310-S), and

15 percent by weight of a cresol novalac-type epoxy resin (commercially available from Nippon Kayaku under the trade designation XD-10002-L);

2. a rheology control agent including

0.5 percent by weight of an epoxy silane (commercially available from OSI under the trade designation A-187);

3. a curing agent including

6.5 percent by weight of an imidazole (commercially available from Borregaard under the trade designation CURAMID CN); and

4. an inorganic filler component including

15 percent by weight of an amorphous precipitated silica (commercially available from J. M. Huber Corporation under the trade designation ZEOTHIX 95), and

9 percent by weight of a silica (commercially available from Admatechs under the trade designation. SO-E5).

This formulation also included 4 percent by weight of a diluent (o-cresyl glycidyl ether, commercially available from CVC under the trade designation GE-10).

Three other formulations (Sample Nos. 2-4) were prepared having the following components in the amounts noted below in Table 1.

TABLE 1

| | | Sample No./ | | |
|---|---|---|---|---|
| Component | | Amt (Wt %) | | |
| Type | Identity | 2 | 3 | 4 |

| | | | | |
|---|---|---|---|---|
| Epoxy | RE-310-S | 50 | 50 | 50 |
| Resin | XD-10002-L | 15 | 15 | 15 |
| Rheology | A-187 (epoxy) | — | — | — |
| Control Agent | A-1100 (amino) | 0.5 | — | — |
| | A-189 (thiol) | — | 0.5 | — |
| Curing | CURAMID CN | 6.5 | 6.5 | 6.5 |
| Agent | (Imidazole) | | | |
| Inorganic Filler | ZEOTHIX 95 | 15 | 15 | 15 |
| Component | SO-E5 (Silica) | 9 | 9 | 9 |

While the compositions were used upon formation (see below), they may be stored for extended periods of time such as of up to about 3 to about 6 months, at a temperature of about −40° C. without experiencing viscosity increase.

After formation, the composition was transferred to a 10 ml syringe made of non-reactive plastic.

### Physical Properties

The compositions have a variety of properties in both the uncured and cured state which are measurable and useful parameters for the end user in choosing a particular formulation for a desired need.

For instance, in the uncured state, the viscosity and yield point are of interest; in reaching the cured state, the cure schedule is of interest.

The viscostiy allows the end user to determine the rapidity with which the adhesive may be applied during a fabrication process, such as a circuit assembly operation. It may be measured using conventional techniques with a Haacke viscometer.

The yield point (or yield stress) may generally be thought of as the minimum stress required to cause a material to flow.

The cure schedule refers to the time required for the onset of cure to occur at a certain temperature, in a specified period of time. This may be seen in more detail with reference to Table 2.

TABLE 2

| | Property | | | | |
|---|---|---|---|---|---|
| | | Yield | Cure Schedule | | |
| Sample | Viscosity | Point | (secs @ | Shear Strength (psi) | |
| No. | (cps) | (Pa) | 150° C.) | G-10 epoxy | GB steel |
| 1 | 2,150 | 1212 | <180 | 2071 | 2072 |
| 2 | 43,500 | 0.18 | <180 | 1906 | 2075 |
| 3 | 14,280 | 190.9 | <180 | 1938 | 2028 |
| 4 | 9,710 | 515.5 | <180 | 1900 | 1922 |

In the cured state, a variety of properties are useful depending on the end use for which the composition is destined.

For instance, the adhesion provides information on the strength of the bond formed by the cured composition. The glass transition temperature (Tg), which is measured by differential scanning calorimetry (DSC) or by thermal mechanical analysis (TMA), provides information on the hardness and strength of the cured reaction product (or, network), and its behavior with respect to changes in temperature—that is, a higher Tg should afford a material that is better able to withstand elevated temperatures.

The invention being thus described, it will be clear to those of ordinary skill in the art that variations and modifications exist and are intended to be within the present invention, the spirit and scope of which is defined by the claims.

What is claimed is:

1. A rheology controlled epoxy composition capable for use in bonding a silicon substrate to a flex circuit or a flex circuit to a pen body, comprising:
(a) an epoxy resin component;
(b) a rheology control agent selected from the group consisting of epoxysilanes, aminosilanes, trialkoxysilyl isocyanurate derivatives, and combinations thereof;
(c) a curing agent component comprising a member selected from the group consisting of amine compounds, amide compounds, imidazole compounds, and combinations thereof; and
(d) optionally, an inorganic filler component.

2. The composition according to claim 1, wherein the rheology control agent is a member selected from the group consisting of glycidyl trimethoxysilane, gamma-amino propyl triethoxysilane, and combinations thereof.

3. The composition according to claim 1, wherein the inorganic filler component is selected from the group consisting of materials constructed of or containing reinforcing silicas, aluminum oxide, silicon nitride, aluminum nitride, silica-coated aluminum nitride, boron nitride, and combinations thereof.

4. The composition according to claim 1, wherein the amine compound of the curing agent component is selected from the group consisting of diethylenetriamine, triethylenetetramine, diethylaminopropylamine, m-xylenediamine, diaminodiphenylamine, isophoronediamine, menthenediamine, polyamides, and combinations thereof.

5. The composition according to claim 1, wherein the amide compound is dicyandiamide.

6. The composition according to claim 1, wherein the imidazole compound of the curing agent component is selected from the group consisting of imidazole, isoimidazole, 2-methyl imidazole, 2-ethyl-4-methylimidazole, 2,4-dimethylimidazole, butylimidazole, 2-heptadecenyl-4-methylimidazole, 2-methylimidazole, 2-undecenylimidazole, 1-vinyl-2-methylimidazole, 2-undecylimidazole, 2-heptadecylimidazole, 2-ethyl 4-methylimidazole, 1-benzyl-2-methylimidazole, 1-propyl-2-methylimidazole, 1-cyanoethyl-2-methylimidazole, 1-cyanoethyl-2-ethyl-4-methylimidazole, 1-cyanoethyl-2-undecylimidazole, 1-cyanoethyl-2-phenylimidazole, 1-guanaminoethyl-2-methylimidazole, addition products of an imidazole and trimellitic acid, addition products of an imidazole and 2-n-heptadecyl-4-methylimidazole, phenylimidazole, benzylimidazole, 2-methyl-4,5-diphenylimidazole, 2,3,5-triphenylimidazole, 2-styrylimidazole, 1-(dodecyl benzyl)-2-methylimidazole, 2-(2-hydroxyl-4-t-butylphenyl)-4,5-diphenylimidazole, 2-(2-methoxyphenyl)-4,5-diphenylimidazole, 2-(3-hydroxyphenyl)-4,5-diphenylimidazole, 2-(p-dimethylaminophenyl)-4,5-diphenylimidazole, 2-(2-hydroxyphenyl)-4,5-diphenylimidazole, di(4,5-diphenyl-2-imidazole)-benzene-1,4,2-napthyl-4,5-diphenylimidazole, 1-benzyl-2-methylimidazole, 2-p-methoxystyrylimidazole, and combinations thereof.

7. The composition according to claim 1, wherein the curing agent component is used in an amount of from about 1 to about 25 percent by weight, based on the total weight of the composition.

8. The composition according to claim 1, further comprising an anhydride component.

9. The composition according to claim 1 for use in the assembly of ink jet printheads, comprising:
(a) an epoxy resin component, in an amount within the range of about 20 to 65 weight percent, based on the total weight of the composition;
(b) a rheology control agent selected from the group consisting of epoxy silanes ans aminosilanes in an amount up to about 0.5 weight percent, based on the total weight of the composition;
(c) a curing agent component in an amount within the range of 1 to about 25 weight percent, based on the total weight of the composition; and
(d) an inorganic filler component in an amount within the range of about 5 to about 60 weight percent, based on the total weight of the composition.

10. Cancelled.

11. The composition according to claim 1, wherein the composition is adhered to a nozzle plate of an ink jet printhead comprising the nozzle plate having an inner layer, ink passage ways connected to nozzles of the nozzle plate, the passageways allow ink to be ejected from the printhead.

12. The composition according to claim 1, wherein the composition is adhered to at least one side of a substrate.

13. Reaction products formed from the compositions according to any one of claims 1-12.

14. Cancelled.

15. An ink jet printhead comprising a silicon substrate to which is attached by a reaction product of any of the compositions according to claims 1-9 and 11-13 a flex circuit, and a pen body to which is attached by a reaction product of any of the compositions according to claims 1-13 the silicon substrate-flex circuit assembly.

16. A method of using the composition according to any one of claims 1-13, comprising the steps of:
dispensing onto a substrate a sufficient amount of the curable one-part epoxy resin composition,
positioning over the epoxy resin composition dispensed onto the substrate a pen body,
mating the pen body with the substrate to form an assembly, and
exposing the assembly to conditions favorable to effect cure of the curable one-part epoxy resin composition.

17. A method for controlling the rheology of an epoxy-based composition, without compromising the adhesive strength of reaction products of the composition, a the step of which comprises:
adding to an epoxy-based composition an amount of a rheology-control agent sufficient to adjust the rheology of the composition to the desired amount.
